(19) United States
(12) Patent Application Publication
(10) Pub. No.: US 2026/0369863 A1
(43) Pub. Date: Nov. 19, 2026

(54) APPARATUS FOR ADJUSTING ANTENNA, AND ANTENNA SYSTEM

(71) Applicant: Ruijie Networks Co., Ltd., Fuzhou (Fujian) (CN)

(72) Inventors: Daohui LI, Fuzhou (CN); Haiqing LIU, Fuzhou (CN)

(21) Appl. No.: 19/727,045

(22) Filed: Jul. 1, 2026

Related U.S. Application Data
(63) Continuation of application No. PCT/CN2025/124013, filed on Sep. 25, 2025.

(30) Foreign Application Priority Data
Jan. 3, 2025 (CN) 202520015188.0

(51) Int. Cl. H01Q 1/12

(52) U.S. Cl. CPC H01Q 1/1264

(57) ABSTRACT

This application relates to the field of antenna angle adjustment technologies, and in particular, to an apparatus for adjusting an antenna, and an antenna system. The adjustment apparatus includes an antenna mounting bracket, a first rotating shaft, a second rotating shaft, a first adjustment mechanism, and a second adjustment mechanism. The antenna mounting bracket is detachably connected to the antenna, the antenna mounting bracket is rotatably connected to the first rotating shaft, and the antenna mounting bracket is rotatably connected to the second rotating shaft. The first adjustment mechanism includes a first bolt and a first transmission assembly connected to the first bolt. The second adjustment mechanism includes a second bolt and a second transmission assembly connected to the second bolt. The first rotating shaft and the second rotating shaft are perpendicular to each other.

### CROSS-REFERENCE TO RELATED APPLICATIONS

This application is a continuation of International Application No. PCT/CN2025/124013, filed on Sep. 25, 2025, which claims priority to Chinese Patent Application No. 202520015188.0, filed with the China National Intellectual Property Administration on Jan. 3, 2025 and entitled “APPARATUS FOR ADJUSTING ANTENNA, AND ANTENNA SYSTEM” , which are incorporated herein by reference in their entireties.

### TECHNICAL FIELD

This application relates to the field of antenna angle adjustment technologies, and in particular, to an apparatus for adjusting an antenna, and an antenna system.

### BACKGROUND

An antenna is an electrical device for transmitting or receiving radio waves and is a key component in a wireless communication system. When an antenna is mounted at a position such as an iron tower, a holding pole, or a wall, and an antenna angle needs to be adjusted, the antenna usually needs to be manually bent after fastening screws are loosened, to achieve angle adjustment.

### SUMMARY

Example embodiments of this application disclose an apparatus for adjusting an antenna, and an antenna system.

Embodiments of this application provide the following technical solutions:

According to a first aspect, an embodiment of this application provides an apparatus for adjusting an antenna. The adjustment apparatus includes an antenna mounting bracket, a first rotating shaft, a second rotating shaft, a first adjustment mechanism, and a second adjustment mechanism. The antenna mounting bracket is configured to detachably connect to the antenna, the antenna mounting bracket is rotatably connected to the first rotating shaft, and the antenna mounting bracket is rotatably connected to the second rotating shaft. The first adjustment mechanism includes a first bolt and a first transmission assembly connected to the first bolt, and the first transmission assembly is connected to the antenna mounting bracket to allow the first bolt to drive, via the first transmission assembly, the antenna mounting bracket to rotate around the first rotating shaft. The second adjustment mechanism includes a second bolt and a second transmission assembly connected to the second bolt, and the second transmission assembly is connected to the antenna mounting bracket to allow the second bolt to drive, via the second transmission assembly, the antenna mounting bracket to rotate around the second rotating shaft. An axis of the first rotating shaft and an axis of the second rotating shaft are perpendicular to each other.

In the adjustment apparatus in this embodiment of this application, the first bolt is used to drive the first transmission assembly for rotation of the antenna mounting bracket around the first rotating shaft, the second bolt is used to drive the second transmission assembly for rotation of the antenna mounting bracket around the second rotating shaft, the antenna mounting bracket is detachably connected to the antenna, and the bolts have self-locking characteristics, so that hovering of the antenna at any angle can be achieved, thereby achieving fine adjustment of the antenna angle. In addition, the adjustment apparatus in this application has a simple structure and is cost-effective.

In a possible implementation, the adjustment apparatus includes a first mounting bracket. The first transmission assembly includes a first sliding slot and a first slider provided in the first sliding slot, the first sliding slot is provided on the first mounting bracket, and the first slider is threadedly connected to the first bolt to allow the first bolt to drive the first slider to move in the first sliding slot along an axial direction of the first bolt. One end of the first rotating shaft is rotatably connected to the first mounting bracket, the other end of the first rotating shaft is fixedly connected to the antenna mounting bracket, and the antenna mounting bracket is movably connected to the first slider.

In a possible implementation, the adjustment apparatus includes a second mounting bracket. The second transmission assembly includes a second sliding slot and a second slider provided in the second sliding slot, the second sliding slot is provided on the second mounting bracket, and the second slider is threadedly connected to the second bolt to allow the second bolt to drive the second slider to move in the second sliding slot along an axial direction of the second bolt. One end of the second rotating shaft is rotatably connected to the second mounting bracket, the other end of the second rotating shaft is fixedly connected to the antenna mounting bracket, and the antenna mounting bracket is in transmission connection to the second slider.

In a possible implementation, the first rotating shaft is fixedly connected to the second mounting bracket. An end of the second mounting bracket away from the first rotating shaft is provided with a first opening, the first slider is provided with a first protrusion, and the first protrusion extends into the first opening to allow the first slider to drive the second mounting bracket to rotate around the first rotating shaft.

In a possible implementation, a first limiting member is fastened on a surface of the first mounting bracket, the second mounting bracket is provided with a first slot, and the first limiting member extends into the first slot and is slidable relative to the first slot to limit a rotation angle of the second mounting bracket.

In a possible implementation, the antenna mounting bracket is provided with a second opening, the second slider is provided with a second protrusion, and the second protrusion extends into the second opening to allow the second slider to drive the antenna mounting bracket to rotate around the second rotating shaft.

In a possible implementation, a second limiting member is fastened on a surface of the second mounting bracket, the antenna mounting bracket is provided with a second slot, and the second limiting member extends into the second slot and is slidable relative to the second slot to limit a rotation angle of the antenna mounting bracket.

In a possible implementation, the first bolt includes a first bolt head, the first bolt passes through the first sliding slot and then is threadedly connected to a first nut. The first bolt includes a first threaded section and a second threaded section connected to the first threaded section, the first threaded section is configured to threadedly connect to the first slider, and the second threaded section is configured to threadedly connect to the first nut. A first washer is provided between the first nut and the first threaded section, an inner diameter of the first washer is less than a diameter of the first threaded section, the inner diameter of the first washer is greater than a diameter of the second threaded section, and the first washer abuts against an outer wall of the first sliding slot. A second washer is provided between the first threaded section and the first bolt head, and a first elastic member is disposed between the second washer and the first bolt head to cause the second washer to abut against the outer wall of the first sliding slot.

In a possible implementation, the second bolt includes a second bolt head, and the second bolt passes through the second sliding slot and then is threadedly connected to a second nut. The second bolt includes a third threaded section and a fourth threaded section connected to the third threaded section, the third threaded section is configured to threadedly connect to the second slider, and the fourth threaded section is configured to threadedly connect to the second nut. A third washer is provided between the second nut and the third threaded section, an inner diameter of the third washer is less than a diameter of the third threaded section, the inner diameter of the third washer is greater than a diameter of the fourth threaded section, and the third washer abuts against an outer wall of the second sliding slot. A fourth washer is provided between the third threaded section and the second bolt head, and a second elastic member is disposed between the fourth washer and the second bolt head to cause the fourth washer to abut against the outer wall of the second sliding slot.

In a possible implementation, the first elastic member is an elastic gasket or a spring; and/or the second elastic member is an elastic gasket or a spring.

In a possible implementation, the first mounting bracket is provided with a first limiting slot. The adjustment apparatus further includes a third mounting bracket, the third mounting bracket is provided with a second limiting slot, the first limiting slot and the second limiting slot are configured to clamp a holding pole, and the first mounting bracket is detachably connected to the third mounting bracket via a first fastener.

In a possible implementation, the antenna mounting bracket includes a mounting portion, and the mounting portion is configured to cooperate with an accommodation slot on the antenna to limit movement of the antenna along a first direction. Along the first direction, an end of the mounting portion is provided with a protruding structure, and the protruding structure is configured to engage with a recess on the antenna to limit movement of the antenna along a second direction. The first direction and the second direction are perpendicular to each other.

In a possible implementation, the mounting portion is provided with a mounting hole, and the mounting hole is for mounting a first connecting member that connects the mounting portion to the antenna.

According to a second aspect, an embodiment of this application provides an antenna system. The antenna system includes the antenna and the adjustment apparatus of the first aspect.

In a possible implementation, along the second direction, both ends of the antenna are each provided with an accommodation slot and a recess. The antenna mounting bracket includes the mounting portion, and the mounting portion is configured to cooperate with the accommodation slot to limit movement of the antenna along the first direction. Along the first direction, the end of the mounting portion is provided with the protruding structure, and the protruding structure is configured to engage with the recess to limit movement of the antenna along the second direction. The first direction and the second direction are perpendicular to each other.

Because the antenna system includes the adjustment apparatus in the first aspect of this application, the antenna system can achieve precise regulation of the antenna angle and hovering at any angle after adjustment. In addition, along the second direction, both ends of the antenna are each provided with the accommodation slot and the recess. In this way, when the antenna mounting bracket is stationary, the entire antenna can rotate and be used, further expanding application scenarios of the adjustment apparatus.

### BRIEF DESCRIPTION OF DRAWINGS

To more clearly describe the technical solutions in embodiments of this application, the drawings to be used in the description of embodiments are briefly introduced below. It is clear that the drawings described below are only some embodiments of this application. For those of ordinary skill in the art, other drawings can also be obtained based on these drawings without creative effort.

FIG. 1 is a schematic diagram of a structure of an apparatus for adjusting an antenna according to an embodiment of this application;

FIG. 2 is a schematic diagram of a structure of an apparatus for adjusting an antenna according to an embodiment of this application;

FIG. 3 is a cross-sectional view at A-A in FIG. 2;

FIG. 4 is a schematic diagram of a structure of an apparatus for adjusting an antenna according to another embodiment of this application;

FIG. 5 is a partial enlarged view of an apparatus for adjusting an antenna according to another embodiment of this application;

FIG. 6 is a schematic diagram of a structure of an antenna system according to an embodiment of this application;

FIG. 7 is a cross-sectional view of an antenna system according to an embodiment of this application; and

FIG. 8 is a side view of an antenna according to an embodiment of this application.

Reference signs: 100. antenna mounting bracket; 110. mounting portion; 111. protruding structure; 200. first adjustment mechanism; 210. first bolt; 211. first bolt head; 210a. first threaded section; 210b. second threaded section; 220. first transmission assembly; 221. first sliding slot; 222. first slider; 222a. first protrusion; 230. first rotating shaft; 240. first nut; 250. first washer; 260. second washer; 270. first elastic member; 300. second adjustment mechanism; 310. second bolt; 311. second bolt head; 310a. third threaded section; 310b. fourth threaded section; 320. second transmission assembly; 321. second sliding slot; 322. second slider; 322a. second protrusion; 330. second rotating shaft; 340. second nut; 350. third washer; 360. fourth washer; 370. second elastic member; 400. first mounting bracket; 410. first limiting member; 500. second mounting bracket; 510. second limiting member; 600. third mounting bracket; 700. first connecting member; and 800. first fastener;
10. antenna; and 20. holding pole; and
01. first opening; 02. first slot; 03. second opening; 04. second slot; 05. accommodation slot; 06. recess; 07. mounting hole; 08. first limiting slot; and 09. second limiting slot.

### DESCRIPTION OF EMBODIMENTS

The technical solutions in embodiments of this application are clearly and thoroughly described below with reference to the drawings in embodiments of this application. It is clear that the described embodiments are only some embodiments of this application, rather than all embodiments. Based on embodiments of this application, all other embodiments obtained by those of ordinary skill in the art without creative effort fall within the protection scope of this application.

The terms “first” and “second” are used only for the purpose of description, but cannot be understood as indicating or implying relative importance or implicitly indicating the number of technical features indicated. Thus, features defined with “first” and “second” may explicitly or implicitly include one or more of these features. In the description of this application, unless otherwise specified, “a plurality of” means two or more.

An antenna is an electrical device for transmitting or receiving radio waves and is a key component in a wireless communication system. A higher operating frequency of the antenna indicates higher sensitivity to an angle change. A related adjustment mechanism cannot precisely adjust an antenna angle, and cannot self-lock after adjustment, easily leading to deviation and low adjustment precision. This brings much inconvenience to users and affects use experience and effect. There are also some antenna angle adjustment mechanisms on the market that can support angle fine-tuning. The antenna angle adjustment mechanism usually includes a worm gear structure and a motor, often with a complex structure and high costs.

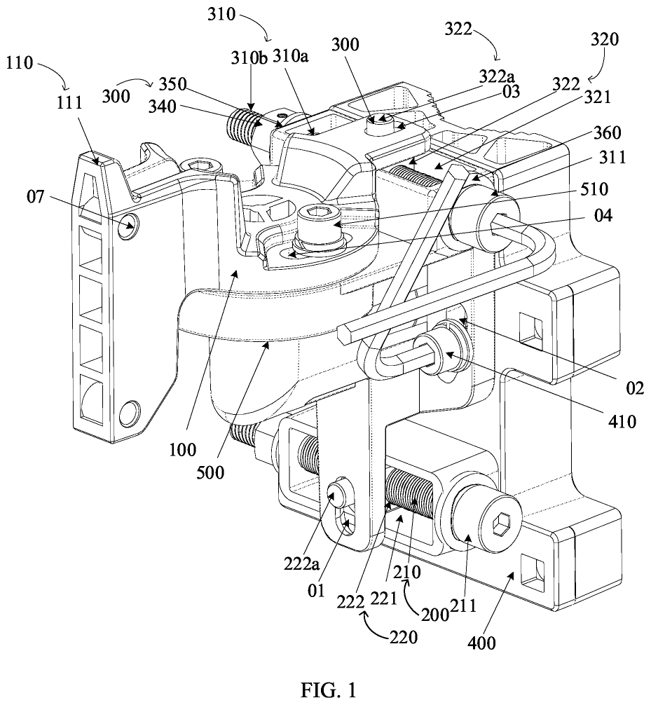

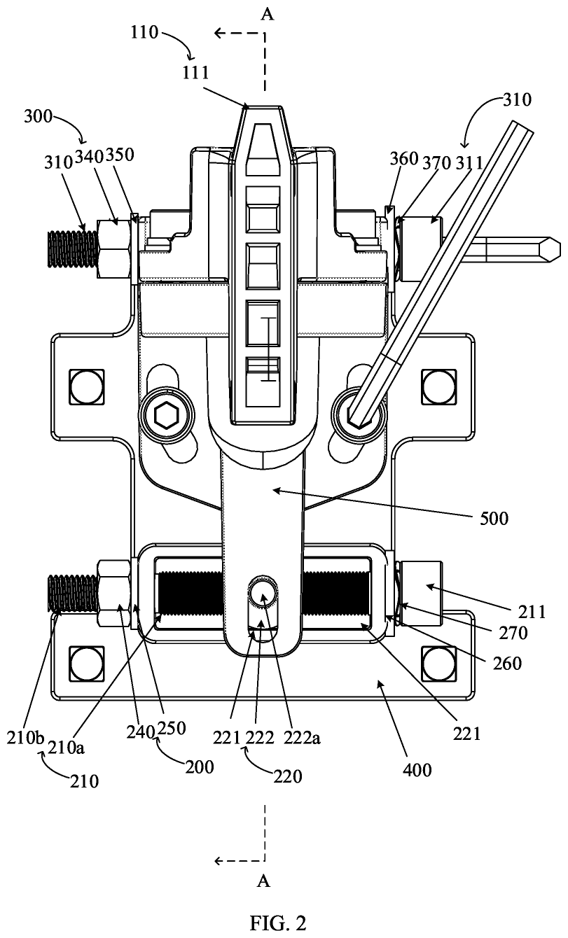

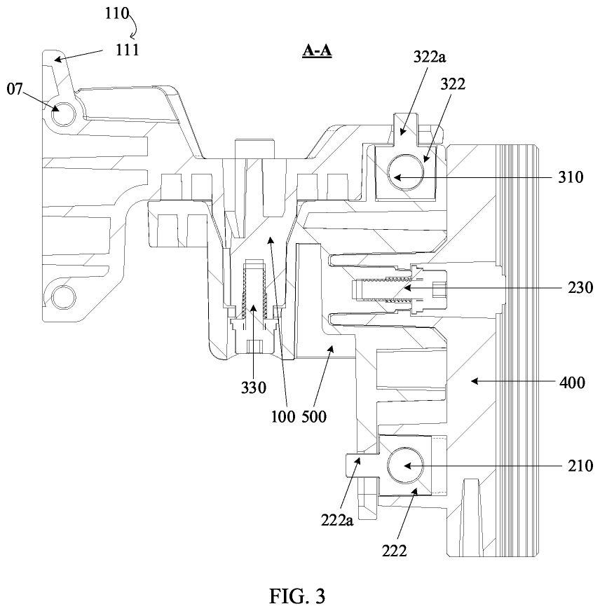

An embodiment of this application provides an apparatus for adjusting an antenna. FIG. 1 is a schematic diagram of a structure of an apparatus for adjusting an antenna according to an embodiment of this application, FIG. 2 is a schematic diagram of a structure of an apparatus for adjusting an antenna according to an embodiment of this application, and FIG. 3 is a cross-sectional view at A-A in FIG. 2. Refer to FIGS. 1 to 3 together. The adjustment apparatus includes an antenna mounting bracket 100, a first rotating shaft 230, a second rotating shaft 330, a first adjustment mechanism 200, and a second adjustment mechanism 300. The antenna mounting bracket 100 is configured to detachably connect to the antenna, the antenna mounting bracket 100 is fixedly connected to the first rotating shaft 230 and is rotatable around the first rotating shaft 230, and the antenna mounting bracket 100 is fixedly connected to the second rotating shaft 330 and is rotatable around the second rotating shaft 330. The first adjustment mechanism 200 includes a first bolt 210 and a first transmission assembly 220 connected to the first bolt 210, and the first transmission assembly 220 is connected to the antenna mounting bracket 100 to cause the first bolt 210 to drive, via the first transmission assembly 220, the antenna mounting bracket 100 to rotate around the first rotating shaft 230. The second adjustment mechanism 300 includes a second bolt 310 and a second transmission assembly 320 connected to the second bolt 310, and the second transmission assembly 320 is connected to the antenna mounting bracket 100 to cause the second bolt 310 to drive, via the second transmission assembly 320, the antenna mounting bracket 100 to rotate around the second rotating shaft 330. An axis of the first rotating shaft 230 and an axis of the second rotating shaft 330 are perpendicular to each other.

When the adjustment apparatus is in an upright state, an axial direction of the first rotating shaft 230 is a horizontal direction, and the first adjustment mechanism 200 is configured to adjust a pitch angle of the antenna 10; and an axial direction of the second rotating shaft 330 is a vertical direction, and the second adjustment mechanism 300 is configured to adjust a horizontal angle of the antenna 10.

In some optional embodiments, the adjustment apparatus includes a first mounting bracket 400, and the first mounting bracket 400 is configured for connection to a supporting structure such as a wall or a holding pole. One end of the first rotating shaft 230 is fixedly connected to the antenna mounting bracket 100, the other end of the first rotating shaft 230 is rotatably connected to the first mounting bracket 400, and the first bolt 210 can drive, via the first transmission assembly 220, the antenna mounting bracket 100 to rotate around the first rotating shaft 230 relative to the first mounting bracket 400.

It can be understood that the first transmission assembly 220 in embodiments of this application is configured to convert axial motion of the first bolt 210 into rotation of the antenna mounting bracket 100. The first transmission assembly 220 includes but is not limited to a slider and sliding slot assembly, a chain and sprocket assembly, a coupling, a gear, a gearbox, and the like. Optionally, the first transmission assembly 220 is a slider and sliding slot assembly, which has a simple structure and is cost-effective in production and maintenance. An example in which the first transmission assembly 220 is a slider and sliding slot assembly is used for description in the following embodiments.

Refer to FIGS. 1 to 3. The first transmission assembly 220 includes a first sliding slot 221 and a first slider 222 provided in the first sliding slot 221, the first sliding slot 221 is provided on the first mounting bracket 400, and the first slider 222 is threadedly connected to the first bolt 210 to cause the first bolt 210 to drive the first slider 222 to move in the first sliding slot 221 along only an axial direction of the first bolt 210. One end of the first rotating shaft 230 is rotatably connected to the first mounting bracket 400, the other end of the first rotating shaft 230 is fixedly connected to the antenna mounting bracket 100, and the antenna mounting bracket 100 is in transmission connection to the first slider 222. During rotation of the first bolt 210, the first slider 222 can move along the axial direction of the first bolt 210, but cannot rotate along the axial direction under the limitation of the first sliding slot 221. In addition, the first slider 222 drives the antenna mounting bracket 100 to rotate around the first rotating shaft 230. In the above adjustment process, because the first bolt 210 is threadedly connected to the first slider 222, and has self-locking characteristics, hovering of the antenna mounting bracket 100 at any angle can be achieved.

In some optional embodiments, the adjustment apparatus includes a second mounting bracket 500, and the second mounting bracket 500 is disposed between the antenna mounting bracket 100 and the first mounting bracket 400. The second mounting bracket 500 is rotatably connected to the first mounting bracket 400 via the first rotating shaft 230. Specifically, one end of the first rotating shaft 230 is fixedly connected to the second mounting bracket 500, the other end of the first rotating shaft 230 is rotatably connected to the first mounting bracket 400, and the second mounting bracket 500 is fixedly connected to the antenna mounting bracket 100 along a direction perpendicular to the first rotating shaft 230, so the second mounting bracket 500 can drive the antenna mounting bracket 100 to rotate around the first rotating shaft 230 relative to the first mounting bracket 400. In addition, one end of the second rotating shaft 330 is fixedly connected to the antenna mounting bracket 100, and the other end of the second rotating shaft 330 is rotatably connected to the second mounting bracket 500, so the antenna mounting bracket 100 rotates around the second rotating shaft 330 relative to the second mounting bracket 500.

It can be understood that the second transmission assembly 320 in this application is configured to convert axial motion of the second bolt 310 into rotation of the antenna mounting bracket 100. The second transmission assembly 320 includes but is not limited to a slider and sliding slot assembly, a chain and sprocket assembly, a coupling, a gear, a gearbox, and the like. Optionally, the second transmission assembly 320 is a slider and sliding slot assembly, which has a simple structure and is cost-effective in production and maintenance. An example in which the second transmission assembly 320 is a slider and sliding slot assembly is used for description in the following embodiments.

Refer to FIGS. 1 to 3. The second transmission assembly 320 includes a second sliding slot 321 and a second slider 322 provided in the second sliding slot 321, the second sliding slot 321 is provided on the second mounting bracket 500, and the second slider 322 is threadedly connected to the second bolt 310 to cause the second bolt 310 to drive the second slider 322 to move in the second sliding slot 321 along only an axial direction of the second bolt 310. One end of the second rotating shaft 330 is rotatably connected to the second mounting bracket 500, the other end of the second rotating shaft 330 is fixedly connected to the antenna mounting bracket 100, and the antenna mounting bracket 100 is in transmission connection to the second slider 322. During rotation of the second bolt 310, the second slider 322 can move along the axial direction of the second bolt 310, but cannot rotate along the axial direction under the limitation of the second sliding slot 321. In addition, the second slider 322 drives the antenna mounting bracket 100 to rotate around the second rotating shaft 330. In the above adjustment process, because the second bolt 310 is threadedly connected to the second slider 322, and has self-locking characteristics, hovering of the antenna mounting bracket 100 at any angle can be achieved.

In some optional embodiments, the first rotating shaft 230 is fixedly connected to the second mounting bracket 500. An end of the second mounting bracket 500 away from the first rotating shaft 230 is provided with a first opening 01, the first slider 222 is provided with a first protrusion 222a, and the first protrusion 222a extends into the first opening 01 to cause the first slider 222 to drive the second mounting bracket 500 to rotate around the first rotating shaft 230. The first opening 01 may be an elongated hole, allowing the relative movement between the first protrusion 222a and the first opening 01, so that axial movement of the first slider 222 along the first bolt 210 can be converted into rotation of the second mounting bracket 500 around the first rotating shaft 230.

In some optional embodiments, a first limiting member 410 is fastened on a surface of the first mounting bracket 400, the second mounting bracket 500 is provided with a first slot 02, and the first limiting member 410 extends into the first slot 02 and is slidable relative to the first slot 02 to limit a rotation angle of the second mounting bracket 500. Optionally, the first slot 02 may be an arc-shaped slot. Optionally, the first limiting member 410 may be a screw. When the first limiting member 410 abuts against an inner wall of the first slot 02, the second mounting bracket 500 stops rotating, to limit the rotation angle of the second mounting bracket 500.

In some optional embodiments, the antenna mounting bracket 100 is provided with a second opening 03, the second slider 322 is provided with a second protrusion 322a, and the second protrusion 322a extends into the second opening 03 to cause the second slider 322 to drive the antenna mounting bracket 100 to rotate around the second rotating shaft 330. The second opening 03 may be an elongated hole, allowing the relative movement between the second protrusion 322a and the second opening 03, so that axial movement of the second slider 322 along the second bolt 310 can be converted into rotation of the antenna mounting bracket 100 around the second rotating shaft 330.

In some optional embodiments, a second limiting member 510 is fastened on a surface of the second mounting bracket 500, the antenna mounting bracket 100 is provided with a second slot 04, and the second limiting member 510 extends into the second slot 04 and is slidable relative to the second slot 04 to limit a rotation angle of the antenna mounting bracket 100. Optionally, the second slot 04 may be an arc-shaped slot. Optionally, the second limiting member 510 may be a screw. When the second limiting member 510 abuts against an inner wall of the second slot 04, the antenna mounting bracket 100 stops rotating, to limit the rotation angle of the antenna mounting bracket 100.

In some optional embodiments, the first bolt 210 includes a first bolt head 211, and the first bolt 210 passes through the first sliding slot 221 and then is threadedly connected to a first nut 240. The first bolt 210 includes a first threaded section 210a and a second threaded section 210b connected to the first threaded section 210a. The first threaded section 210a is configured to threadedly connect to the first slider 222, and the second threaded section 210b is configured to threadedly connect to the first nut 240. A first washer 250 is provided between the first nut 240 and the first threaded section 210a, an inner diameter (a diameter of an inner ring) of the first washer 250 is less than a diameter of the first threaded section 210a, the inner diameter of the first washer 250 is greater than a diameter of the second threaded section 210b, and the first washer 250 abuts against an outer wall of the first sliding slot 221, to reduce an axial gap between the second threaded section 210b and the first sliding slot 221, and reduce an axial gap between the first bolt 210 and the first mounting bracket 400.

In some optional embodiments, a second washer 260 is provided between the first threaded section 210a and the first bolt head 211, and a first elastic member 270 is disposed between the second washer 260 and the first bolt head 211. Under the action of the first elastic member 270, the second washer 260 always abuts against the outer wall of the first sliding slot 221, thereby reducing an axial gap between the first bolt 210 and the first sliding slot 221, improving adjustment precision of a position of the antenna mounting bracket 100, and avoiding shaking after the antenna is mounted.

The first elastic member 270 is an elastic gasket or a spring.

In some optional embodiments, the second bolt 310 includes a second bolt head 311, and the second bolt 310 passes through the second sliding slot 321 and then is threadedly connected to a second nut 340. The second bolt 310 includes a third threaded section 310a and a fourth threaded section 310b connected to the third threaded section 310a, the third threaded section 310a is configured to threadedly connect to the second slider 322, and the fourth threaded section 310b is configured to threadedly connect to the second nut 340. A third washer 350 is provided between the second nut 340 and the third threaded section 310a, an inner diameter of the third washer 350 is less than a diameter of the third threaded section 310a, the inner diameter of the third washer 350 is greater than a diameter of the fourth threaded section 310b, and the third washer 350 abuts against an outer wall of the second sliding slot 321, to reduce an axial gap between the fourth threaded section 310b and the second sliding slot 321, and reduce an axial gap between the second bolt 310 and the second mounting bracket 500.

In some optional embodiments, a fourth washer 360 is provided between the third threaded section 310a and the second bolt head 311, and a second elastic member 370 is disposed between the fourth washer 360 and the second bolt head 311. Under the action of the second elastic member 370, the fourth washer 360 always abuts against the outer wall of the second sliding slot 321, thereby reducing an axial gap between the second bolt head 311 and the second sliding slot 321, reducing an axial gap between the second bolt 310 and the second mounting bracket 500, improving the adjustment precision of the position of the antenna mounting bracket 100, and avoiding shaking after the antenna is mounted.

The second elastic member 370 is an elastic gasket or a spring.

The adjustment apparatus in embodiments of this application may be mounted on a supporting structure such as a wall or an iron tower, or may be mounted on a holding pole.

In some optional embodiments, when the adjustment apparatus is mounted on a wall or an iron tower, the adjustment apparatus can be fastened to the wall or the iron tower via screws, bolts, and the like.

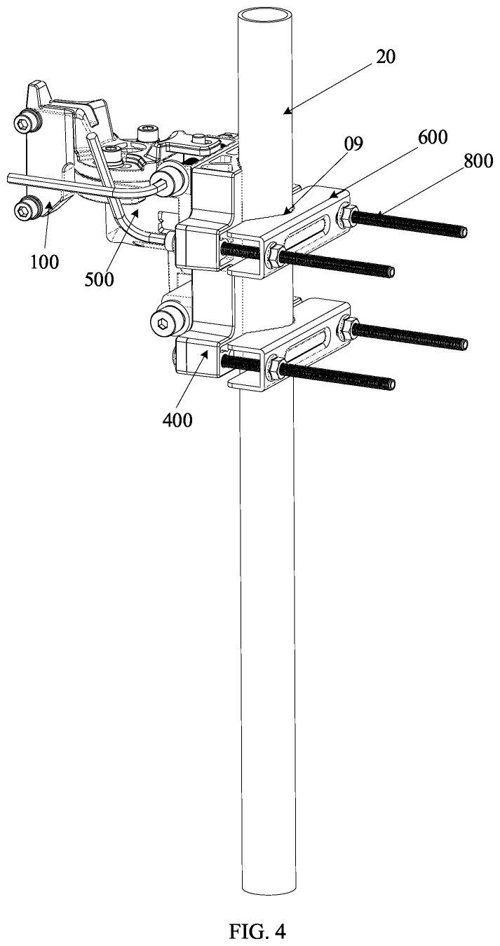

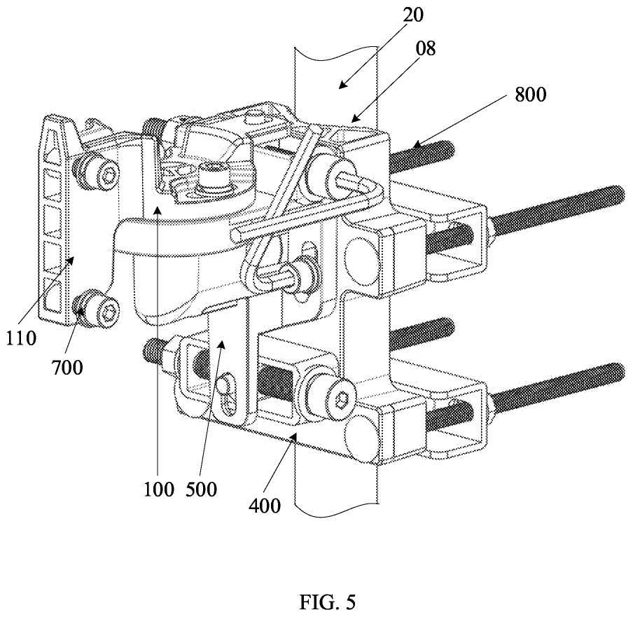

FIG. 4 is a schematic diagram of a structure of an apparatus for adjusting an antenna according to another embodiment of this application, and FIG. 5 is a partial enlarged view of an apparatus for adjusting an antenna according to another embodiment of this application. Refer to FIGS. 4 and 5. During mounting of the adjustment apparatus and a holding pole 20, the adjustment apparatus further includes a third mounting bracket 600. The first mounting bracket 400 is provided with a first limiting slot 08, the third mounting bracket 600 is provided with a second limiting slot 09, the first limiting slot 08 and the second limiting slot 09 are configured to clamp the holding pole 20, and the first mounting bracket 400 is detachably connected to the third mounting bracket 600 via a first fastener 800. The first fastener 800 includes a bolt, a screw, and the like.

As shown in FIGS. 4 and 5, the first mounting bracket 400 and the third mounting bracket 600 are fastened via bolts and nuts to clamp the holding pole 20, thereby fastening the antenna 10 onto the holding pole 20. Shapes of the first limiting slot 08 and the second limiting slot 09 are set according to a shape of the holding pole 20. Optionally, an inner wall of the first limiting slot 08 is provided with serrations to increase a force of friction between the first mounting bracket 400 and the holding pole. Similarly, an inner wall of the second limiting slot 09 may be provided with serrations to increase a force of friction between the third mounting bracket 600 and the holding pole.

It can be understood that this application does not limit a detachable connection mode between the antenna mounting bracket 100 and the antenna. For example, a mode of connection between the antenna mounting bracket 100 and the antenna includes at least one of engagement, threaded connection, riveting, and flange connection.

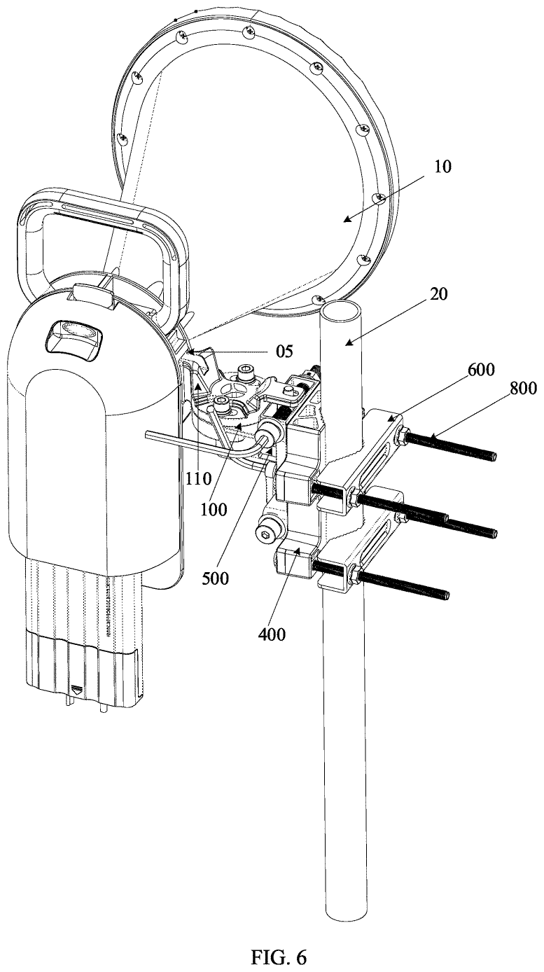

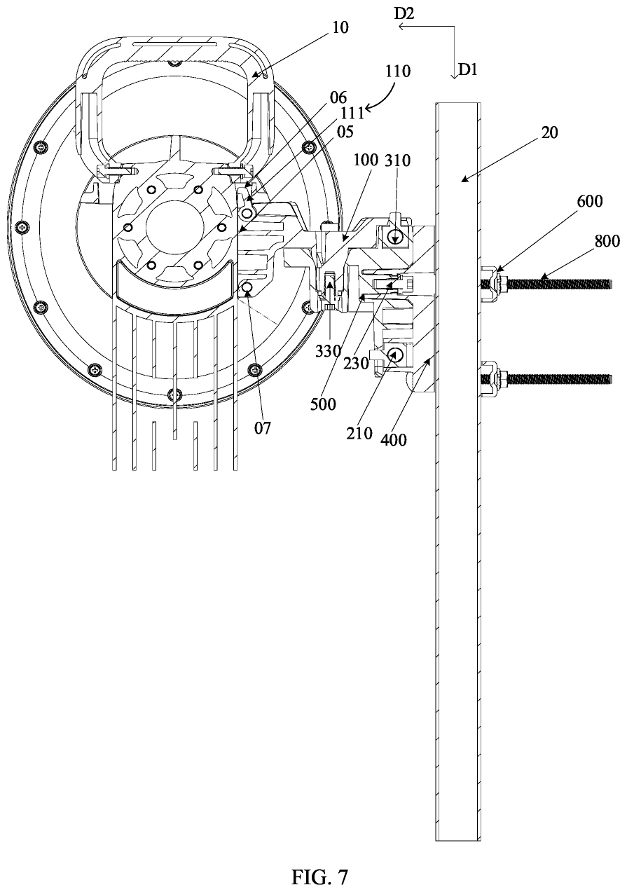

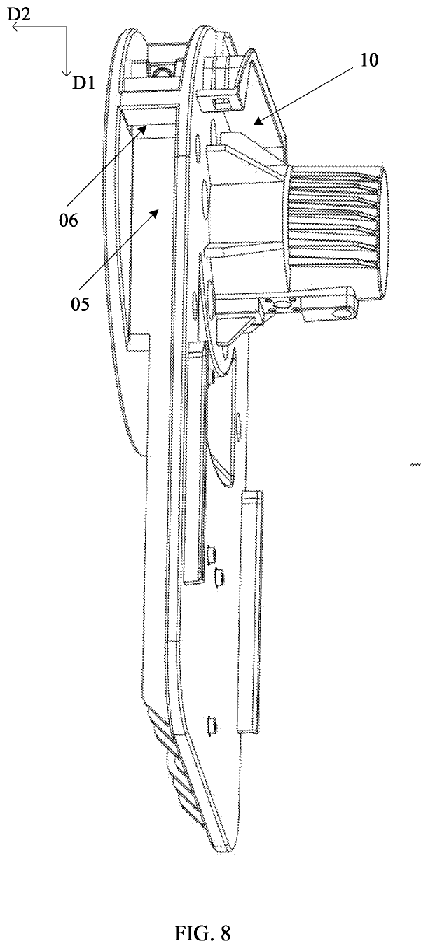

FIG. 6 is a schematic diagram of a structure of an antenna system according to an embodiment of this application, FIG. 7 is a cross-sectional view of an antenna system according to an embodiment of this application, and FIG. 8 is a side view of an antenna according to an embodiment of this application. Refer to FIGS. 6 to 8 together. The antenna mounting bracket 100 includes a mounting portion 110, the mounting portion 110 is configured to cooperate with an accommodation slot 05 on the antenna 10 to limit movement of the antenna 10 along a first direction D1. As shown in FIG. 7, the first direction D1 is a gravity direction. The mounting portion 110 can be located at an end of the antenna mounting bracket 100 away from the first mounting bracket 400, to avoid interference between the antenna 10 and a supporting structure such as a holding pole 20.

In some optional embodiments, along the first direction D1, an end of the mounting portion 110 is provided with a protruding structure 111, and the protruding structure 111 is configured to engage with a recess 06 on the antenna 10. As shown in FIG. 8, an opening of the recess 06 faces downward, and the protruding structure 111 extends into the recess 06 from the opening, to limit movement of the antenna mounting bracket 100 along a second direction D2. The first direction D1 and the second direction D2 are perpendicular to each other.

In some optional embodiments, refer to FIGS. 5 and 7. The mounting portion 110 is provided with a mounting hole 07, and the mounting hole 07 is for mounting a first connecting member 700 that connects the mounting portion 110 to the antenna 10. The mounting hole 07 may be a threaded hole, and the first connecting member 700 may be a bolt or a screw.

Based on the same technical idea, an embodiment of this application further provides an antenna system. The antenna system includes the antenna and the adjustment apparatus in the possible embodiments of this application. As shown in FIGS. 6 and 7, along the second direction D2, both ends of the antenna 10 are each provided with an accommodation slot 05 and a recess 06, the two accommodation slots 05 are symmetrically provided on two sides of a centerline of the antenna 10, and the two recesses 06 are symmetrically provided on the two sides of the centerline of the antenna 10. In this way, when the antenna mounting bracket 100 is stationary, the entire antenna 10 can rotate 180° and be used, further expanding application scenarios of the adjustment apparatus.

The structures of the antenna mounting bracket 100 and the antenna 10 have been described in detail above. A process of mounting the antenna 10 and the antenna mounting bracket 100 is specifically described below:

The mounting portion 110 of the antenna mounting bracket 100 is aligned with the accommodation slot 05 on the antenna 10. When the mounting portion 110 is inserted into the accommodation slot 05, the protruding structure 111 extends into the recess 06 on the antenna 10 and engages with the recess 06, thereby hanging the antenna 10 on the antenna mounting bracket 100.

The first connecting member 700 passes through the mounting hole 07 of the mounting portion 110 and is connected to the antenna 10, to achieve fixed connection between the antenna 10 and the antenna mounting bracket 100.

In summary, the antenna system and the apparatus for adjusting the antenna in this application have the following advantages:
(1) The first bolt can be used to adjust a pitch angle of the antenna, and the second bolt can be used to adjust a horizontal angle of the antenna, so that precise regulation of an antenna angle is achieved, and hovering at any angle can be achieved.
(2) The first bolt and the second bolt are axially limited via washers and elastic members, to avoid shaking of the antenna and improve antenna adjustment precision.
(3) The antenna and the antenna mounting bracket are designed separately, and are detachably connected to each other, facilitating quick assembly and disassembly and improving convenience.

It is clear that those skilled in the art can make various changes and modifications to embodiments of this application without departing from the spirit and scope of this application. Thus, if these modifications and variations of this application fall within the scope of the claims of this application and their equivalents, this application is also intended to include these modifications and variations.

What is claimed is:

1. An apparatus for adjusting an antenna, comprising:
an antenna mounting bracket (100), wherein the antenna mounting bracket (100) is configured to detachably connect to the antenna (10);
a first rotating shaft (230), wherein the antenna mounting bracket (100) is rotatably connected to the first rotating shaft (230);
a second rotating shaft (330), wherein the antenna mounting bracket (100) is rotatably connected to the second rotating shaft (330);
a first adjustment mechanism (200), wherein the first adjustment mechanism (200) comprises a first bolt (210) and a first transmission assembly (220) connected to the first bolt (210), and the first transmission assembly (220) is connected to the antenna mounting bracket (100) to allow the first bolt (210) to drive, via the first transmission assembly (220), the antenna mounting bracket (100) to rotate around the first rotating shaft (230); and
a second adjustment mechanism (300), wherein the second adjustment mechanism (300) comprises a second bolt (310) and a second transmission assembly (320) connected to the second bolt (310), and the second transmission assembly (320) is connected to the antenna mounting bracket (100) to allow the second bolt (310) to drive, via the second transmission assembly (320), the antenna mounting bracket (100) to rotate around the second rotating shaft (330), wherein
an axis of the first rotating shaft (230) and an axis of the second rotating shaft (330) are perpendicular to each other.

2. The adjustment apparatus according to claim 1, wherein the adjustment apparatus further comprises a first mounting bracket (400);
the first transmission assembly (220) comprises a first sliding slot (221) and a first slider (222) located in the first sliding slot (221), the first sliding slot (221) is provided on the first mounting bracket (400), and the first slider (222) is threadedly connected to the first bolt (210) to allow the first bolt (210) to drive the first slider (222) to move in the first sliding slot (221) along an axial direction of the first bolt (210); and
one end of the first rotating shaft (230) is rotatably connected to the first mounting bracket (400), the other end of the first rotating shaft (230) is fixedly connected to the antenna mounting bracket (100), and the antenna mounting bracket (100) is movably connected to the first slider (222).

3. The adjustment apparatus according to claim 1, wherein the adjustment apparatus comprises a second mounting bracket (500);
the second transmission assembly (320) further comprises a second sliding slot (321) and a second slider (322) provided in the second sliding slot (321), the second sliding slot (321) is provided on the second mounting bracket (500), and the second slider (322) is threadedly connected to the second bolt (310) to allow the second bolt (310) to drive the second slider (322) to move in the second sliding slot (321) along an axial direction of the second bolt (310); and
one end of the second rotating shaft (330) is rotatably connected to the second mounting bracket (500) the other end of the second rotating shaft (330) is fixedly connected to the antenna mounting bracket (100), and the antenna mounting bracket (100) is in transmission connection to the second slider (322).

4. The adjustment apparatus according to claim 3, wherein the first rotating shaft (230) is fixedly connected to the second mounting bracket (500); and
an end of the second mounting bracket (500) away from the first rotating shaft (230) is provided with a first opening (01), the first slider (222) is provided with a first protrusion (222a), and the first protrusion (222a) extends into the first opening (01) to allow the first slider (222) to drive the second mounting bracket (500) to rotate around the first rotating shaft (230).

5. The adjustment apparatus according to claim 4, wherein a first limiting member (410) is fastened on a surface of the first mounting bracket (400), the second mounting bracket (500) is provided with a first slot (02), and the first limiting member (410) extends into the first slot (02) and is slidable relative to the first slot (02) to limit a rotation angle of the second mounting bracket (500).

6. The adjustment apparatus according to claim 4, wherein the antenna mounting bracket (100) is provided with a second opening (03), the second slider (322) is provided with a second protrusion (322a), and the second protrusion (322a) extends into the second opening (03) to allow the second slider (322) to drive the antenna mounting bracket (100) to rotate around the second rotating shaft (330).

7. The adjustment apparatus according to claim 6, wherein a second limiting member (510) is fastened on a surface of the second mounting bracket (500), the antenna mounting bracket (100) is provided with a second slot (04), and the second limiting member (510) extends into the second slot (04) and is slidable relative to the second slot (04) to limit a rotation angle of the antenna mounting bracket (100).

8. The adjustment apparatus according to claim 3, wherein the first bolt (210) comprises a first bolt head (211), and the first bolt (210) passes through the first sliding slot (221) and then is threadedly connected to a first nut (240), wherein
the first bolt (210) comprises a first threaded section (210a) and a second threaded section (210b) connected to the first threaded section (210a), the first threaded section (210a) is threadedly connected to the first slider (222), and the second threaded section (210b) is threadedly connected to the first nut (240).

9. The adjustment apparatus according to claim 8, wherein a first washer (250) is provided between the first nut (240) and the first threaded section (210a), an inner diameter of the first washer (250) is less than a diameter of the first threaded section (210a), the inner diameter of the first washer (250) is greater than a diameter of the second threaded section (210b), and the first washer (250) abuts against an outer wall of the first sliding slot (221); and
a second washer (260) is provided between the first threaded section (210a) and the first bolt head (211), and a first elastic member (270) is disposed between the second washer (260) and the first bolt head (211) to cause the second washer (260) to abut against the outer wall of the first sliding slot (221).

10. The adjustment apparatus according to claim 9, wherein the second bolt (310) comprises a second bolt head (311), and the second bolt (310) passes through the second sliding slot (321) and then is threadedly connected to a second nut (340), wherein
the second bolt (310) comprises a third threaded section (310a) and a fourth threaded section (310b) connected to the third threaded section (310a), the third threaded section (310a) is threadedly connected to the second slider (322), and the fourth threaded section (310b) is threadedly connected to the second nut (340).

11. The adjustment apparatus according to claim 10, wherein a third washer (350) is provided between the second nut (340) and the third threaded section (310a), an inner diameter of the third washer (350) is less than a diameter of the third threaded section (310a), the inner diameter of the third washer (350) is greater than a diameter of the fourth threaded section (310b), and the third washer (350) abuts against an outer wall of the second sliding slot (321); and
a fourth washer (360) is provided between the third threaded section (310a) and the second bolt head (311), and a second elastic member (370) is disposed between the fourth washer (360) and the second bolt head (311) to cause the fourth washer (360) to abut against the outer wall of the second sliding slot (321).

12. The adjustment apparatus according to claim 11, wherein the first elastic member (270) is an elastic gasket or a spring; and/or the second elastic member (370) is an elastic gasket or a spring.

13. The adjustment apparatus according to claim 2, wherein the first mounting bracket (400) is provided with a first limiting slot (08); and
the adjustment apparatus further comprises a third mounting bracket (600), the third mounting bracket (600) is provided with a second limiting slot (09), the first limiting slot (08) and the second limiting slot (09) clamp a holding pole (20), and the first mounting bracket (400) is detachably connected to the third mounting bracket (600) via a first fastener (800).

14. The adjustment apparatus according to claim 1, wherein the antenna mounting bracket (100) further comprises a mounting portion (110), the mounting portion (110) cooperates with an accommodation slot (05) on the antenna (10) to limit movement of the antenna (10) along a first direction; and
along the first direction, an end of the mounting portion (110) is provided with a protruding structure (111), and the protruding structure (111) engages with a recess (06) on the antenna (10) to limit movement of the antenna (10) along a second direction, wherein
the first direction and the second direction are perpendicular to each other.

15. The adjustment apparatus according to claim 14, wherein the mounting portion (110) is provided with a mounting hole (07), and the mounting hole (07) is for mounting a first connecting member (700) that connects the mounting portion (110) to the antenna (10).

16. An antenna system, comprising the antenna (10) and the adjustment apparatus according to claim 1.

17. The antenna system according to claim 16, wherein along the second direction, both ends of the antenna (10) are each provided with an accommodation slot (05) and a recess (06);
the antenna mounting bracket (100) comprises the mounting portion (110), and the mounting portion (110) cooperates with the accommodation slot (05) to limit movement of the antenna (10) along the first direction; and
along the first direction, the end of the mounting portion (110) is provided with the protruding structure (111), and the protruding structure (111) engages with the recess (06) to limit movement of the antenna (10) along the second direction, wherein
the first direction and the second direction are perpendicular to each other.
